(19) United States
(12) Patent Application Publication
(10) Pub. No.: US 2013/0243907 A1
(43) Pub. Date: Sep. 19, 2013

(54) SYSTEM AND METHOD FOR MAKING ORGANIC COTTAGE CHEESE

(71) Applicant: John E. Stauffer, Greenwich, CT (US)

(72) Inventor: John E. Stauffer, Greenwich, CT (US)

(21) Appl. No.: 13/886,650

(22) Filed: May 3, 2013

Related U.S. Application Data
(63) Continuation of application No. 12/943,188, filed on Nov. 10, 2010.

(51) Int. Cl. A23C 19/032; A23C 19/076

(52) U.S. Cl. CPC A23C 19/0325; A23C 19/076
USPC 426/37; 426/582

(57) ABSTRACT

A process is disclosed for the manufacture of cottage cheese from milk using citric acid to precipitate the curd. The citric acid is supplied by fermentation of the lactose contained in the byproduct whey.

### RELATED APPLICATIONS

This application is a continuation of application Ser. No. 12/943,188 filed Nov. 10, 2010 which application is incorporated herein by reference.

### TECHNICAL FIELD

Embodiments of a method for making cottage cheese relate to cheese making and cheese products.

### BACKGROUND

Cottage cheese is a popular food item, particularly in the United States where consumption is growing rapidly. Although demand is somewhat seasonal, summertime showing the greatest usage, cottage cheese is a nutritious food that many consumers find appealing

The standard method of producing cottage cheese is to inoculate low fat- or fat free milk with a lactic acid producing organism. Many microbes fulfill this requirement, including strains of lactococci and lactobacilli bacteria. Upon the addition of a starter culture to the milk, the microbe produces lactic acid, which causes the coagulation of a curd. The precipitate is separated from the watery whey to provide the cottage cheese. Various additives and ingredients may be mixed with the curd to produce commercial products.

Notwithstanding the popularity of cottage cheese products, opportunities are apparent for line extensions. Consumer palates are constantly searching for a new experience. Furthermore, a growing interest in organic foods is driving consumers to seek out new brands.

While the food technology used in producing cottage cheese is mature, room for improvements exists. Large volume manufacturing needs processes that are efficient and reliable. Finally, there is the challenge of extending the shelf-life of consumer products made from cottage cheese.

For these and other reasons, Systems and Methods for Making Cottage Cheese are designed to offer advantages over current practice. Various objects, features and advantages of Systems and Methods for Making Cottage Cheese will become apparent from the following description, including the FIGURE that is provided.

### SUMMARY

In one embodiment, a method of manufacturing cottage cheese to minimize waste includes producing citric acid from a first lot whey by treating the first lot of whey; precipitating cottage cheese curd from milk using the citric acid; recovering a second lot of whey by separating the cottage cheese curd from the whey; and repeating the method by using the second lot of whey to create citric acid. Optionally, Aspergillus niger is used in the treating of the first lot of whey. In one alternative the method further includes filtering the second lot of whey to produce whey protein. In another alternative the method further includes boiling the second lot of whey to produce whey protein. Optionally, only the lactose of the first lot of whey and the second lot of whey is used to produce the citric acid. Alternatively, the first lot of whey, the milk, and the Aspergillus niger are organic, thereby retaining the organic nature of the cottage cheese curd and second lot of whey produced.

In another embodiment a method of manufacturing cottage cheese to minimize waste includes producing citric acid from a first lot of lactose resulting from a first lot of whey by treating the first lot of whey with Aspergillus niger; precipitating cottage cheese curd from milk using the citric acid; recovering a second lot of whey by separating the cottage cheese curd from the whey; filtering the second lot of whey to produce whey protein and a second lot of lactose; repeating the method by using the second lot of lactose from the second lot of whey to create citric acid. Optionally, the first lot of whey, the milk, and the Aspergillus niger are organic, thereby retaining the organic nature of the cottage cheese curd and second lot of whey produced. Embodiments also include Cottage cheese made by the processes noted above.

In one embodiment the required citric acid may be obtained by fermenting lactose using a culture of Aspergillus niger. This lactose is recovered from the byproduct whey by extracting protein from the whey. In another embodiment a unified process, milk and starter culture lead to the production of cottage cheese in three steps: 1. Milk coagulation, 2. Whey separation, and 3. Lactose fermentation. In many of the embodiments, the resulting cottage cheese curd may be processed with various additives and ingredients to achieve the desired organoleptic properties and to improve the handling and keeping attributes of the product.

### BRIEF DESCRIPTION OF THE DRAWINGS

FIG. 1 is a block diagram showing one embodiment of a method of making cottage cheese.

### DETAILED DESCRIPTION OF THE DRAWINGS

In the following detailed description of the illustrative embodiments, reference is made to the accompanying drawings that form a part hereof. These embodiments are described in sufficient detail to enable those skilled in the art to practice methods of making cottage cheese and related products and methods, and it is understood that other embodiments may be utilized and that logical structural, mechanical, electrical, and chemical changes may be made without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

In one embodiment a method of making cottage is characterized by using citric acid as the means of precipitating cottage cheese curd from milk. Depending on the desired fat content of the curd, low fat- or fat free milk can be used. As is standard with the manufacture of most dairy products, the milk will first be pasteurized.

Citric acid has several advantages as an acidulent in the process described herein. Citric acid is found in many fruits and vegetables, notably citrus fruits. Thus, it is common in most people's diets. The acid has a pleasing taste. While possessing a definite tartness, its taste is considered to be more “neutral” compared with other acids, e.g., acetic acid.

The functionality of citric acid is also significant. It is quite soluble in water. Citric acid is a relatively strong organic acid with the first dissociation constant of 8.2 x at 18° C. Although citric acid does not inhibit microbial growth per se, it improves the effectiveness of such preservatives as benzoic acid and sorbic acid by lowering the pH of the product.

The level of addition of citric acid to the milk is sufficient to provide a firm curd and to achieve good separation from the whey. Compared with culturing milk, the addition and mixing of the acid is rapid and can be tightly controlled. Furthermore, lower temperatures are permitted. These factors allow greater efficiency and reproducibility in the production of cheese, especially on a large scale.

The cheese curd is separated from the watery liquid known as whey. The byproduct whey for many years was considered to be a waste stream. Instead whey may be recovered for environmental reasons as well as to produce the valuable food ingredient whey protein.

The separation of whey protein from whey can be accomplished by alternative means. When whey is heated to boiling temperature for 30 minutes or so, the protein in it will denature and precipitate. Although this process is straightforward, the resulting protein has limited functionality. Another method for separating protein from whey employs ultrafiltration to produce a whey protein concentrate of considerable utility.

After removing protein from the whey, a stream of lactose or milk sugar remains. Rather than discarding the lactose, this carbohydrate can be used as a medium for fermentation. Inoculation with the mold Aspergillus niger will produce citric acid. Studies have been undertaken for the production of citric acid from whey with promising results. (Y. A. EI-Samragy et al. Dairy, Food and Environmental Sanitation, November 1993, pages 638-641). The conditions closely parallel those used for the commercial production of citric acid from molasses. Thus, a self-contained process can be achieved whereby citric acid from lactose fermentation is recycled to the milk coagulation stage. Because all of the raw ingredients are potentially organic, cottage cheese made by this process may be considered to be organic.

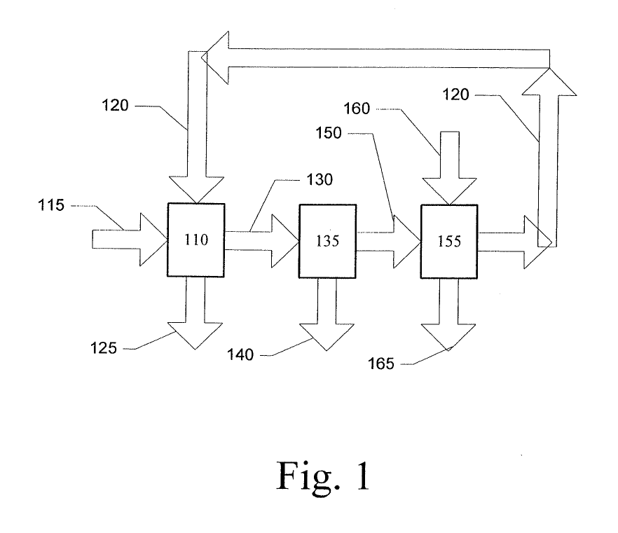

FIG. 1 shows one embodiment of a method of making cottage cheese. In block 110, milk 115 and citric acid 120 are combined. Cottage Cheese Curd 125 results and is strained from whey 130. In block 135, ultrafiltration used to separate whey protein 140 from lactose 150. In block 155 the lactose 150 is combined with starter culture 160 and yields citric acid 120 and mycelium 165.

The cottage cheese produced by the above method is sufficiently differentiated from existing products to permit new formulations. Sweeteners, e.g., sugar, can be incorporated to balance the tartness of the citric acid. Because the underlying taste of the curd is bland, various other flavors can be introduced. Some of the new creations are well suited for blending with fruit such as mangos and blueberries.

### EXAMPLE

A solution of citric acid was prepared by dissolving 11.1 gm. of Citric Acid USP-FCC Anhydrous in 100 ml. of water. Two teaspoons of this solution was added to half a cup of cold Fat Free Milk, Grade A, Pasteurized. Upon stirring, a precipitate formed. The curds separated from the milk, resulting in a flocculation. Then the curds were filtered through coffee filter paper. The filtrate was a clear pale yellow solution. The floc filtered rapidly forming a snow white cake. A sample of the curd was tasted. The sensation was acidic but with a bland, neutral background taste. Overall the result was pleasing.

What is claimed:

1. A method of manufacturing cottage cheese to minimize waste, comprising:
producing citric acid from a first lot of whey by treating the first lot of whey;
precipitating cottage cheese curd from milk using the citric acid;
recovering a second lot of whey by filtering the cottage cheese curd from the whey; and
repeating the method by using the second lot of whey to create citric acid.

2. The method of claim 1, wherein Aspergillus niger is used in the treating of the first lot of whey.

3. The method of claim 1, further comprising:
filtering the second lot of whey to produce whey protein.

4. The method of claim 1, further comprising:
boiling the second lot of whey to produce whey protein.

5. The method of claim 1 wherein only the lactose of the first lot of whey and the second lot of whey is used to produce the citric acid.

6. The method of claim 2, wherein the first lot of whey, the milk, and the Aspergillus niger are organic, thereby retaining the organic nature of the cottage cheese curd and the second lot of whey produced.

7. A method of manufacturing cottage cheese to minimize waste, comprising:
producing citric acid from a first lot of lactose resulting from a first lot of whey by treating the first lot of whey with Aspergillus niger;
precipitating cottage cheese curd from milk using the citric acid;
recovering a second lot of whey by filtering the cottage cheese curd from the whey;
filtering the second lot of whey to produce whey protein and a second lot of lactose;
repeating the method by using the second lot of lactose from the second lot of whey to create citric acid.

8. The method of claim 7, wherein the first lot of whey, the milk, and the Aspergillus niger are organic, thereby retaining the organic nature of the cottage cheese curd and the second lot of whey produced.

9. Cottage cheese made by the process according to claim 1.

10. Cottage cheese made by the process according to claim 7.
